(19) United States
(12) Patent Application Publication
(10) Pub. No.: US 2023/0334312 A1
(43) Pub. Date: Oct. 19, 2023

(54) INFORMATION PROCESSING APPARATUS AND INFORMATION PROCESSING METHOD

(71) Applicant: SONY GROUP CORPORATION, TOKYO (JP)

(72) Inventor: JUN NISHIKAWA, TOKYO (US)

(21) Appl. No.: 18/044,661

(22) PCT Filed: Aug. 11, 2021
(86) PCT No.: PCT/JP2021/029610

§ 371 Date: Mar. 9, 2023

(30) Foreign Application Priority Data
Sep. 17, 2020 (JP) 2020-156336

(51) Int. Cl. G06N 3/08

(52) U.S. Cl. CPC G06N 3/08

(57) ABSTRACT

The information processing apparatus is configured to have a filter elimination processing section for eliminating a filter whose dispersion is less than a threshold value in a neural network having a Depthwise convolution layer, a Pointwise convolution layer, and a Batch normalization layer, and have a quantization processing section for performing quantization of the neural network.

### TECHNICAL FIELD

The present technique relates to an information processing apparatus and an information processing method for quantization of a neural network.

### BACKGROUND ART

Neural networks have been utilized in various information processing apparatuses. The amount of computation required for learning processing and analysis processing (inference processing) by neural networks is enlarging, and techniques for efficient processing are required.

In view of these problems, quantization techniques for neural networks have been proposed. By quantizing the neural network, the number of bits of each parameter can be reduced, and a computation cost can be greatly reduced.

However, in the quantization of neural networks, there is a case where the dynamic range of parameters expands and appropriate quantization is difficult.

NPL 1 below claims that a cause of this problem is Batch Normalization (hereinafter referred to as “BN”) used in a combination of Depthwise Convolution (hereinafter referred to as “DC”) and the BN, and proposes an architecture without using BN after DC to address this problem.

### CITATION LIST

### Patent Literature

[NPL 1]
Tao Sheng, Chen Feng, Shaojie Zhuo, Xiaopeng Zhang, Liang Shen, Mickey Aleksic, “A Quantization-Friendly Separable Convolution for MobileNets,” 2018 1st Workshop on Energy Efficient Machine Learning and Cognitive Computing for Embedded Applications, doi:10.1109/EMC2.2018.00011

### SUMMARY

### Technical Problem

Incidentally, in the case of trying to use a learning model generated in a state where each parameter used in the neural network is represented with a large number of bits (for example, 32 bits) in a computer device with low processing ability, it is conceivable to transplant the learning model to the computer device after reducing the amount of computation related to the inference processing by quantizing the neural network to represent each parameter with a small number of bits (for example, 8 bits).

However, in order to obtain the effect described in NPL 1 when quantizing a learning model having a conventional network structure, the learning model having a conventional network structure needs to be subjected to quantization after being reconstructed into a learning model having a network structure described in NPL 1 (a structure in which BN is not arranged after DC).

As a result, there is a problem that a processing load of the processing related to the reconstruction of the learning model performed before quantization increases, and also it takes a lot of time to finish quantization.

The present technique has been made in view of the circumstances described above, and aims to reduce the amount of computation for inference processing while reducing the cost associated with constructing a learning model.

### Solution to Problem

An information processing apparatus according to the present technique includes a filter elimination processing section that eliminates filters whose variance is smaller than a threshold in a neural network having a Depthwise convolution layer, a Pointwise convolution layer, and a Batch normalization layer, and a quantization processing section for performing quantization of the neural network.

By eliminating filters with small variance, the neural network can be quantized while maintaining the magnitude relation and difference between respective parameters as much as possible.

The filter elimination processing section in the information processing apparatus described above may set a filter in the Batch normalization layer subsequent to the Depthwise convolution layer as the filter to be eliminated.

A filter with small variance exists in a subsequent stage of the Depthwise convolution layer, especially in the Batch normalization layer immediately thereafter.

The filter elimination processing section in the information processing apparatus described above, the filter elimination processing section may perform processing of replacing the output value of the Batch normalization layer with an approximate expression in the elimination of the filter.

This makes it possible to reduce the quantization error.

The information processing apparatus described above may include an adjustment processing section that adjusts parameters in a convolution layer provided in a subsequent stage of the Batch normalization layer from which the filter has been eliminated.

For example, the parameters are adjusted so that the effect of eliminating the filter on the inference performance is reduced.

The adjustment processing section in the information processing apparatus described above may adjust bias parameters of the convolution layer provided in a subsequent stage of the Batch normalization layer.

This can reduce the influence of filter elimination on inference results.

The information processing apparatus described above may include an incorporation processing section that incorporates parameters in the Batch normalization layer into another convolution layer.

This makes it possible, for example, to eliminate layers subjected to the filter elimination.

The incorporation processing section in the information processing apparatus described above may execute processing to incorporate the parameters in the Batch normalization layer into a preceding Depthwise convolution layer.

As a result, the functions acquired by the Batch normalization layer as a learning result are integrated into the Depthwise convolution layer.

In the information processing apparatus described above, a variable to be added to the denominator to avoid division by zero in the Batch normalization layer may be used, as the threshold.

This eliminates the need for the user to enter the threshold.

An information processing method according to the present technique, which is executed by a computer device, includes elimination processing of filters whose variance is smaller than a threshold in a neural network having a Depthwise convolution layer, a Pointwise convolution layer, and a Batch normalization layer, and includes quantization processing of the neural network.

Also with such an information processing method, an effect similar to that of the information processing apparatus according to the present technique described above can be obtained.

An information processing apparatus according to the present technique includes a quantization processing section that quantizes a neural network, and the quantization processing section quantizes activation data in the neural network and quantizes weight data in the neural network separately.

As a result, changes in inference results due to quantization of activation data and changes in inference results due to quantization of weight data are reduced compared to a case where both are quantized at one time.

The information processing apparatus described above may include a learning model generating section that performs relearning processing after the quantization of the activation data and after the quantization of the weight data, respectively.

By relearning, the optimal learning model that has changed due to quantization can be followed.

In the information processing apparatus described above, the neural network has a Depthwise convolution layer, a Pointwise convolution layer, and a Batch normalization layer, and a filter elimination processing section that eliminates a filter whose variance is smaller than a threshold in the neural network may be provided.

By eliminating filters with small variance, the neural network can be quantized while maintaining the magnitude relation and difference between respective parameters as much as possible.

The quantization processing section in the above information processing apparatus may perform the quantization of the activation data and the quantization of the weight data after elimination of the filters by the filter elimination processing section.

As a result, quantization and relearning are performed with the dynamic range of the parameters narrowed.

The filter elimination processing section in the information processing apparatus described above may eliminate the filters before and after the quantization of the activation data, respectively.

As a result, even in a case where a problematic filter that widens the dynamic range appears after quantization of the activation data, the filter is eliminated.

The filter elimination processing section in the information processing apparatus described above eliminates the filters only once, and the quantization processing section may perform the quantization of the activation data and the quantization of the weight data after the filter elimination executed once.

Due to this, the time required for filter elimination processing can be shortened.

An information processing method executed by a computer device according to the present technique is such that quantization of activation data in a neural network and quantization of weight data in the neural network are separately performed.

With such an information processing method, an effect similar to that of the information processing apparatus according to the present technique described above can be obtained.

### BRIEF DESCRIPTION OF DRAWINGS

FIG. 1 is an explanatory diagram of quantization error.

FIG. 2 is a diagram illustrating an example of a layer configuration of a neural network executed by an information processing apparatus according to the present technique.

FIG. 3 is a block diagram of a computer device.

FIG. 4 is a diagram illustrating a functional block diagram of the information processing apparatus.

FIG. 5 is a flow chart illustrating an example of a processing flow for quantization of the neural network.

FIG. 6 is a flowchart illustrating an example of filter elimination processing.

FIG. 7 is a flow chart illustrating another example of the processing flow for quantization of the neural network.

### DESCRIPTION OF EMBODIMENTS

Hereinafter, embodiments according to the present technique will be described in the following order with reference to the accompanying drawings.

<1. Harmful Effects of DNN Quantization>

<2. General DNN Layer Configuration>

<3. Configuration of Information Processing Apparatus>

<4. Quantization Flow>

<5. Modification Example>

<6. Summary>

<7. Present Technique>

### 1. Harmful Effects of DNN Quantization

An information processing apparatus 1 according to the present technique is capable of executing various computations for image recognition processing by a DNN (Deep Neural Network), which is a type of neural network.

For example, the information processing apparatus 1 builds a learning model by learning using a DNN. The learning model constructed by the processing of the information processing apparatus 1 is used for inference processing in the information processing apparatus 1 or other computer devices. To be specific, by inputting any image data into the constructed learning model, processing of inferring a subject in an image is performed. This makes it possible to classify subjects and the like.

The information processing apparatus 1 can be applied not only to high-performance PCs (Personal Computers) and computer devices, but also to smart phones, small computer devices, and the like.

The processing of building a learning model by using a DNN and the processing of analyzing input image data are computationally expensive, so that there is a risk that smartphones and small computer devices that do not have high computational processing capabilities will not be able to exhibit adequate performance.

Therefore, it is preferable to perform quantization of the DNN.

For example, parameters used in a DNN include activation data which is input data for each layer, and weight data which is coefficients used for computation. Appropriate inference results can be obtained by using a learning model obtained by representing each of these parameters in 32 bits.

However, if the number of bits of each parameter is increased up to 32 bits or the like, a high-performance learning model can be obtained, but the computation cost increases. The computation cost here includes not only the time cost required for the computation but also a hardware cost.

DNN quantization aims to reduce the computation cost by reducing the number of bits of each parameter used in the DNN. That is, it means that each parameter represented by 32 bits is represented by a small number of bits such as 8 bits or 4 bits.

However, the quantization of the DNN has not only the advantage of being able to significantly reduce the amount of computations to make the DNN lighter, but also the disadvantage of degrading the correctness of the inference results (that is, degrading the performance).

In DNN quantization, it is preferable to minimize this drawback as much as possible.

As degradation in inference performance due to DNN quantization, degradation due to quantization errors and degradation during reconstruction of a learning model after quantization can be considered.

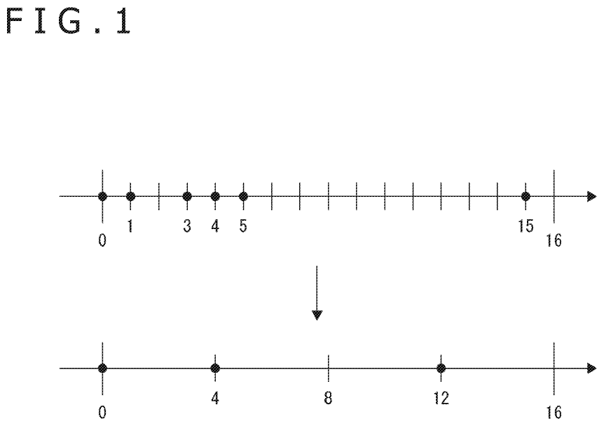

Here, performance degradation due to quantization error will be described with reference to FIG. 1.

For example, a case where quantization is performed so that a parameter represented in 4 bits before is represented in 2 bits is considered.

A parameter represented by 4 bits can take a value in the range of 0 to 15, for example. Also, a parameter represented by 2 bits can take a value in the range of 0 to 3, for example.

The 4-bit parameters that take values of [4, 3, 0, 1, 5, 15] are represented by 2-bit parameters as [1, 0, 0, 0, 1, 3]. That is, the values 0 to 3 in 4 bits are converted to “0” in 2 bits, the values 4 to 7 in 4 bits are converted to “1” in 2 bits, and the values 8 to 11 in 4 bits are converted to “2” in 2 bits, and a value of 12 to 15 in 4 bits is converted to “3” in 2 bits.

This is synonymous with converting the parameters [4, 3, 0, 1, 5, 15] to [4, 0, 0, 0, 4, 12], and this means that the originally possessed difference between the second parameter “3” and the third parameter “0” is lost due to quantization. Also, it means that the difference between the first parameter “4” and the second parameter “3” comes to be expressed so as to become larger by quantization (see FIG. 1).

In such a way, the learning model, which has been optimized by using parameters expressed in 4 bits, is no longer the optimal learning model due to quantization, and the inference performance degrades.

Incidentally, the 4-bit parameters that take values of [4, 3, 0, 1, 5, 15] can greatly narrow the range of values that can be taken if a value of “15” is not included (narrow the range to 0 to 5). That is, the parameters represented by [4, 3, 0, 1, 5, 15] can reduce the step size during quantization if the value “15” is not present, and the problem of dynamic range is resolved, so that the quantization error can be reduced.

Note that the variance σ of the 4-bit parameters that take the values [4, 3, 0, 1, 5, 15] is reduced compared with parameters that are evenly distributed in the range of 0 to 15 (for example, [4, 2, 9, 14, 7, 11]).

Therefore, by eliminating filters that generate parameters that reduce the variance σ, the dynamic range can be improved and the quantization error can be reduced.

However, simply eliminating the filters is highly likely to affect the inference result, and it is desirable to perform parameter adjustment processing together so as not to affect the inference result.

### 2. General DNN Layer Configuration

As a general DNN layer configuration for realizing a reduction in the amount of computation associated with processing for building learning models and inference processing in a DNN, a configuration including a DC (Depthwise Convolution) layer and a PC (Pointwise Convolution) layer is known.

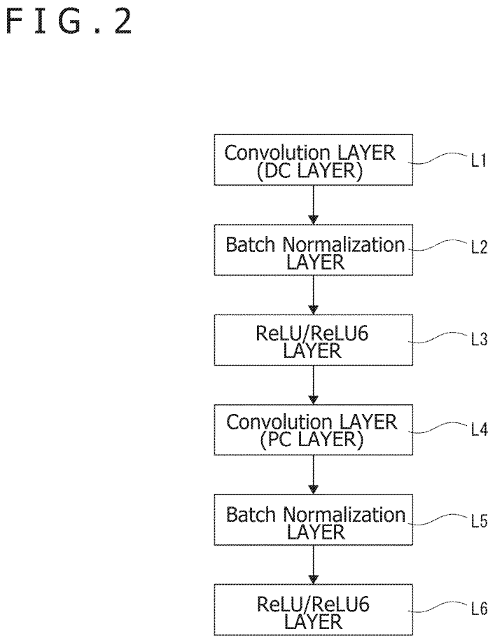

For example, as illustrated in FIG. 2, the configuration is one in which a DC layer (convolution layer) L1, BN (Batch Normalization) layer L2, ReLU (Rectified Linear Unit)/ReLU6 layer L3, PC layer (convolution layer) L4, BN layer L5, and ReLU/ReLU6 layer L6 are provided in this order.

In such a layer configuration, the reason that the parameter variance is small as described above is that the BN layer L2 is arranged immediately after the DC layer L1.

### 3. Configuration of Information Processing Apparatus

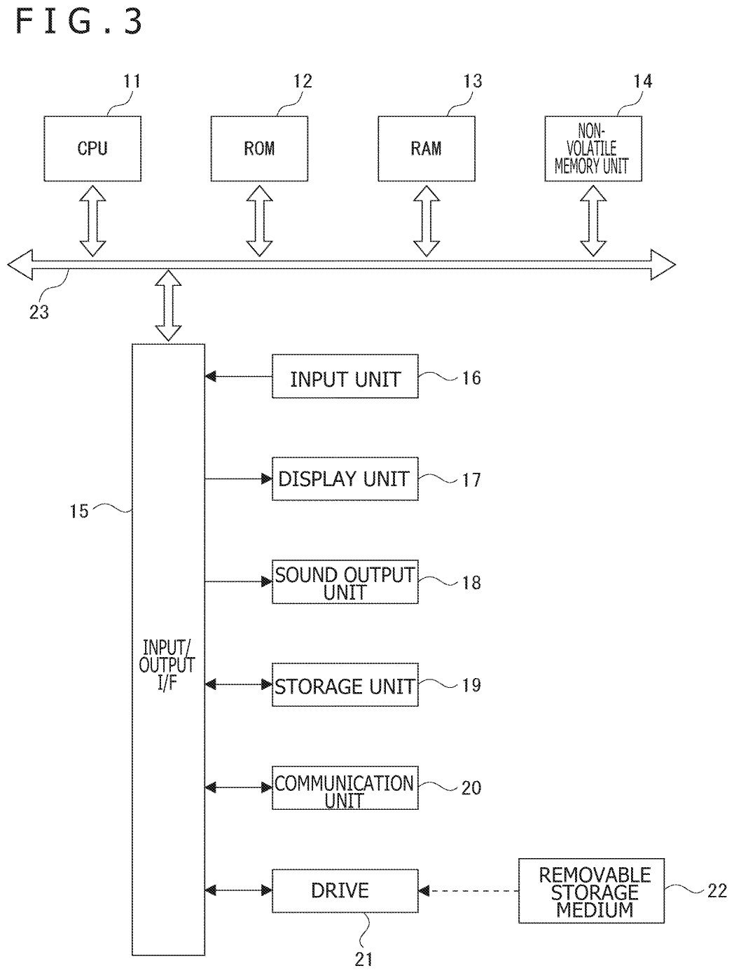

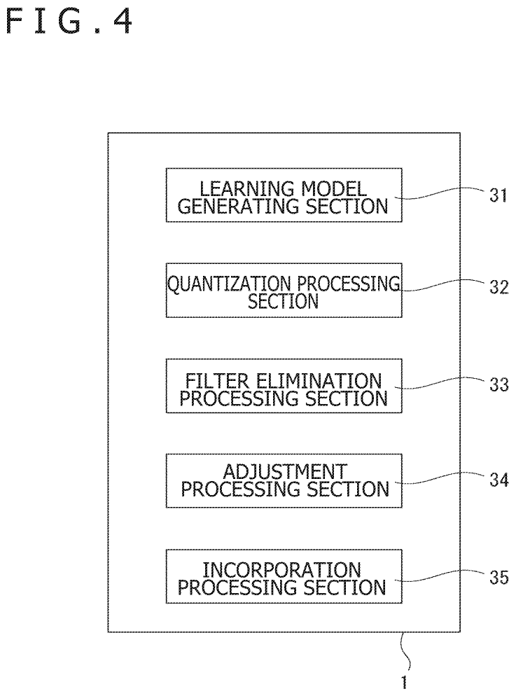

A configuration example of the information processing apparatus 1 that performs DNN quantization will be described with reference to FIGS. 3 and 4.

A block diagram of a computer device as the information processing apparatus 1 is illustrated in FIG. 3.

The CPU 11 of the computer device performs various types of processing according to programs stored in a non-volatile memory unit 14 such as a ROM 12 or an EEP-ROM (Electrically Erasable Programmable Read-Only Memory), or programs loaded from a storage unit 19 to a RAM 13. The RAM 13 also appropriately stores data necessary for a CPU 11 to execute various types of processing.

The CPU 11, the ROM 12, the RAM 13, and the non-volatile memory unit 14 are interconnected via a bus 23. An input/output interface (I/F) 15 is also connected to the bus 23.

An input unit 16 including operating elements and operating devices is connected to the input/output interface 15.

For example, as the input unit 16, various operating elements and operating devices such as a keyboard, a mouse, keys, dials, a touch panel, a touch pad, or a remote controller are assumed.

A user's operation is detected by the input unit 16, and a signal corresponding to the input operation is interpreted by the CPU 11.

Further, the input/output interface 15 is connected integrally or separately with a display unit 17 including an LCD, an organic EL panel, or the like, and a sound output unit 18 including a speaker or the like.

The display unit 17 is a display unit that performs various displays, and has, for example, a display device provided on the housing of the computer device, a separate display device connected to the computer device, and the like.

The display unit 17 displays images for various types of image processing, moving images to be processed, etc. on the display screen on the basis of instructions from the CPU 11. Further, the display unit 17 performs displays of various operation menus, icons, messages, etc., that is, displays as a GUI (Graphical User Interface) on the basis of instructions from the CPU 11.

There are also cases where the storage unit 19 including a hard disk, a solid-state memory, etc., or a communication unit 20 including a modem or the like may be connected to the input/output interface 15.

The communication unit 20 performs communication processing via a transmission line such as the Internet, and communication with various devices by wired/wireless communication, bus communication, and the like.

A drive 21 is also connected to the input/output interface 15 as required, and a removable storage medium 22 such as a magnetic disk, an optical disk, a magneto-optical disk, or a semiconductor memory is appropriately mounted.

From the removable storage medium 22, data files such as programs used for DNN processing and image data to be subjected to inference processing or image data as teacher data, or the like can be read by the drive 21. The read data file is stored in the storage unit 19, and the image and sound contained in the data file are output by the display unit 17 or the sound output unit 18. Further, computer programs and the like read from the removable storage medium 22 are installed in the storage unit 19 as necessary.

In this computer device, for example, software for the processing according to the present embodiment can be installed via network communication by the communication unit 20 or the removable storage medium 22. Alternatively, the software may be stored in advance in the ROM 12, the storage unit 19, or the like.

The necessary information processing and the communication processing of the information processing apparatus 1 are executed by the CPU 11 performing processing operations on the basis of various programs.

Note that the information processing apparatus 1 as illustrated in FIG. 2 is not limited to being configured with a single computer device, and may be configured by systematizing a plurality of computer devices. The plurality of computer devices may be systematized by a LAN (Local Area Network) or the like, or may be remotely located by a VPN (Virtual Private Network) using the Internet or the like. The plurality of computing devices may include computer devices as a group of servers (cloud) available through a cloud computing service.

By the CPU 11 of the information processing apparatus 1 operating based on the program, the CPU 11 of the information processing apparatus 1 functions as a learning model generating section 31, a quantization processing section 32, a filter elimination processing section 33, an adjustment processing section 34, and an incorporation processing section 35 illustrated in FIG. 4.

The learning model generating section 31 performs machine learning in each layer such as a convolution layer by inputting image data for learning and the like. Through learning, optimal parameters for each layer can be obtained. Then, the learning model generating section 31 acquires a learning model by completing learning.

In addition, the learning model generating section 31 performs relearning processing required according to the quantization of the DNN. This reconstructs a learning model adapted to the quantized parameters.

The quantization processing section 32 performs quantization of activation data and quantization of weight data in a DNN. By performing these types of quantization, it is possible to reduce the amount of parameter data to be handled, and also to greatly reduce the amount of computation for inference processing. The details will be described later.

The filter elimination processing section 33 eliminates filters that reduce the parameter variance σ in the BN layer L2, that is, filters that cause a factor in increasing quantization errors in quantization. The details will be described later.

The adjustment processing section 34 adjusts the parameters in a subsequent convolution layer in order to prevent the filter elimination processing by the filter elimination processing section 33 from greatly affecting the inference results. The details will be described later.

The incorporation processing section 35 performs processing to incorporate the parameters of the BN layer L2 into the immediately preceding convolutional layer (DC layer L1, PC layer L4, etc.). This makes it possible to eliminate the BN layer L2 from the DNN. Also, by incorporating the parameters of the BN layer L2 into the immediately preceding convolutional layer, the functions of the BN layer L2 are integrated into the convolutional layer.

### 4. Quantization Flow

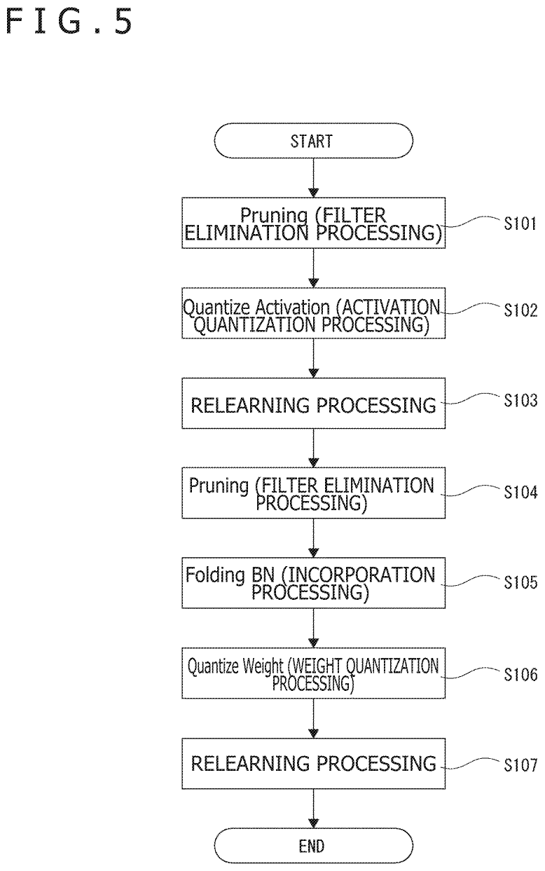

A processing flow when the CPU 11 of the information processing apparatus 1 performs DNN quantization will be described with reference to FIG. 5.

In the quantization of the DNN, first, the CPU 11 executes Pruning processing (filter elimination processing) in step S101.

In filter elimination processing, filters with small variance σ are eliminated. In addition, parameters (coefficients) are adjusted to suppress degradation of inference performance due to elimination of the filters.

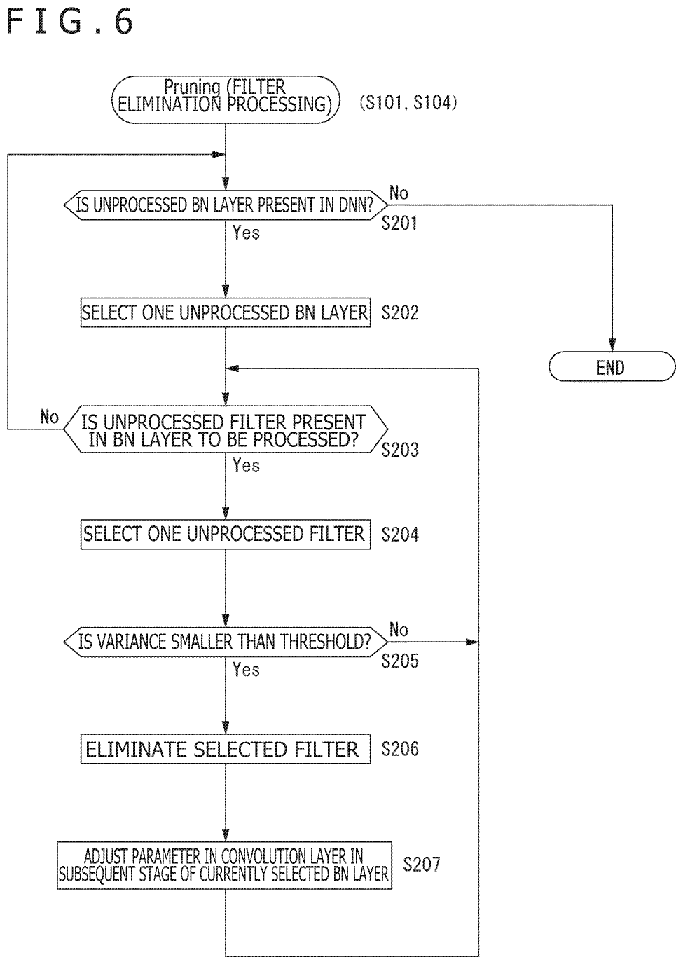

FIG. 6 illustrates an example of filter elimination processing in step S101.

In the filter elimination process, the CPU 11 first determines in step S201 whether or not there is an unprocessed BN layer in the DNN. In a case where there is an unprocessed BN layer, the CPU 11 selects one unprocessed BN layer in step S202 and performs a series of processes from step S203 on the selected BN layer as a processing target.

On the other hand, in step S201, in a case where the series of processes has been executed for all BN layers in the DNN, the CPU 11 ends the filter elimination processing illustrated in FIG. 6.

After selecting one unprocessed BN layer in step S202, the CPU 11 determines in step S203 whether or not an unprocessed filter exists in the BN layer to be processed. In a case where all the filters included in the BN layer have been processed, the CPU 11 returns from step S203 to step S201 and performs determination processing for selecting the next unprocessed BN layer.

On the other hand, in the case of having determined that there is an unprocessed filter, the CPU 11 selects one unprocessed filter in step S204.

Here, the filter computation in the BN layer will be described.

First, the computation of the convolution layer provided before the BN layer can be expressed by the following [Equation 1].

$$\begin{matrix}[ Math . 1 ] & \\ {C}_{( o , s , t )}^{( L )} = {\sum }_{i} {\sum }_{( h , v )} {w}_{( o , i , h , v )}^{( L )} {x}_{( i , s + h , t + v )}^{( L )} + {b}_{( o )}^{( L )} & [ Equation 1 ]\end{matrix}$$

Variable w in [Equation 1] represents weight data, variable x represents activation data, and variable b represents a bias parameter. Further, variables w and b are parameters acquired in learning before DNN quantization.

Next, each variable used as an index for each variable will be described. Variable L is a numerical value that specifies a layer, variable o is a filter index value, and variables s and t are values that specify pixel positions in the output map.

Furthermore, variables h and v are values indicating parameter positions in the filter (kernel) to be used for convolution processing, and variable i is a value for specifying the input image. For example, in a case where three images that are an R (red) image, a G (green) image, and a B (blue) image, are used as input data, and the variable i is a value for specifying which image of the R image, G image, and B image is the input image.

In the filter processing in the BN layer, processing is performed on variable C that is the calculation result of the convolution layer. This arithmetic expression can be represented by the following [Equation 2].

$$\begin{matrix}[ Math . 2 ] & \\ {b}_{( o , s , t )}^{( L )} = \frac{{C}_{( o , s , t )}^{( L )} - {μ}_{( o )}^{( L )}}{\sqrt{{σ}_{( o )}^{( L )} + ε}} {γ}_{( o )}^{( L )} + {β}_{( o )}^{( L )} & [ Equation 2 ]\end{matrix}$$

The variable C in [Equation 2] represents the output value of the preceding convolution layer (that is, the output value of [Equation 1]), variable μ represents the average value, and variable σ represents a variance. Also, variable ε is a small non-zero value that is added to the denominator to avoid division by a zero value. Furthermore, variable γ and variable β are parameters obtained in learning before DNN quantization.

Step S204 in FIG. 6 is a process of selecting filters one by one as represented by [Equation 2].

In the subsequent step S205, the CPU 11 determines whether or not the variance σ is smaller than the threshold. Note that, in the present embodiment, the variable ε is used as the threshold for this determination. This saves time for setting and calculating the threshold.

In the case of having determined that the variance σ is smaller than the threshold, the CPU 11 performs processing to eliminate the currently selected filter in step S206.

Here, elimination of filters will be described.

The variance σ in [Equation 2] described above is calculated by the following [Equation 3].

$$\begin{matrix}[ Math . 3 ] & \\ {σ}_{( o )}^{( L )} = \frac{1}{B \times S \times T} \text{?} {\vert {C}_{( o , s , t )}^{( B , S , T )} - {μ}_{( o )}^{( L )} \vert}^{2} & [ Equation 3 ]\end{matrix}$$

$$\text{?} \text{indicates text missing or illegible when filed}$$

Variable B indicates the number of input maps to be processed (for example, the number of images), and variables S and T indicate the number of vertical pixels and the number of horizontal pixels in one input map. That is, the result of multiplying variable B, variable S, and variable T represents the number of pixels to be processed. Further, variable b is a variable for specifying an input map to be processed.

Here, a small variance σ is synonymous with a small value of the result of the computation represented by [Equation 4] in [Equation 3].

[Math. 4]

C_{(o,s,t)}^{(b,L)}−μ₍ₒ₎^{(L)} [Equation 4]

Here, approximation of [Equation 2] in a case where the variance σ is small is considered. In a case where the variance σ is a small value, the denominator value ([Equation 5]) of the value to be multiplied by the variable γ approaches the variable ε. On the other hand, the value of the numerator ([Equation 6]) approaches zero.

[Math. 5]

\sqrt{σ₍ₒ₎^{(L)}+ε} [Equation 5]

[Math. 6]

C_{(o,s,t)}^{(L)}−μ₍ₒ₎^{(L)} [Equation 6]

That is, the value to be multiplied by the variable γ approaches zero as the variance σ decreases. Accordingly, [Equation 7] below can be obtained by approximation of [Equation 2].

[Math. 7]

B_{(o,s,t)}^{(L)}˜β₍ₒ₎^{(L)} [Equation 7]

The filter elimination processing executed in step S206 of FIG. 6 is a process of performing approximation by using the approximate expression indicated in [Equation 7].

Whether or not to execute elimination of a filter is determined for each filter. That is, only in a case where a filter specified by the variable o has a small value of variance G, the filter is eliminated.

After eliminating the filter, in step S207, the CPU 11 performs processing for adjusting the variable b (bias parameter, see [Equation 1]) to be used in the convolutional layer subsequent to the currently selected BN layer. For example, the subsequent convolutional layer is the PC layer L4 in a case where the elimination processing for the BN layer L2 in FIG. 2 has been executed.

This can minimize the influence of filter elimination on inference results.

The computation of the adjustment processing for the variable b can be represented by the following [Equation 8].

$$\begin{matrix}[ Math . 8 ] & \\ {b}_{( {o}_{L + 1} )}^{( L + 1 )} ← \text{?} + Act ( \text{?} ) \text{?} & [ Equation 8 ]\end{matrix}$$

$$\text{?} \text{indicates text missing or illegible when filed}$$

ô: Specific filter

The Act function represents an activating function. The variable L is assumed to specify the layer as described above. For example, L represents the BN layer L2, and (L+1) represents the PC layer L4.

After adjusting the parameters of the subsequent convolution layer in step S207 of FIG. 6, the CPU 11 proceeds to step S203 to select the next unprocessed filter.

FIG. 5 is referred to again.

After completing the series of processes illustrated in FIG. 6 as the filter elimination processing of step S101, the CPU 11 performs Quantize Activation (activation quantization processing) of step S102.

Incidentally, in DNN quantization, generally, activation data (variable x in [Equation 1]) and weight data (variable w in [Equation 1]) are quantized at one time.

However, if both the activation data and weight data are quantized at one time, there is a high possibility that the input and output data in each layer will change too much during relearning after quantization. As a result, relearning may take a long time, or the performance of the completed learning model may be degraded, resulting in deteriorated inference results.

In the present embodiment, activation data and weight data are quantized separately, and relearning processing is performed for each.

To be specific, activation data is first quantized in step S102. Then, in the following step S103, the CPU 11 performs a relearning processing to restore the learning model that has become non-optimal due to the activation quantization processing to its optimal state. That is, in the relearning process, a learning model according to the quantization of the activation data is constructed.

As a result, relearning can be performed in a state where the amount of change in input data and output data in each layer is suppressed, so that deterioration in inference performance can be suppressed.

Subsequently, the CPU 11 executes Pruning processing (filter elimination processing) in step S104. This processing is similar to the filter elimination processing in step S101. That is, the filter to be eliminated that has been generated again in the activation quantization processing is eliminated.

The CPU 11 performs Folding BN processing (incorporation processing) in step S105. The incorporation processing is a process of incorporating the parameters to be used in the BN layer L2 into the immediately preceding DC layer L1 in order to eliminate the BN layer L2 immediately after the DC layer L1.

The computation of incorporation processing is represented by the following [Equation 9].

$$\begin{matrix}[ Math . 9 ] & \\ w {1}_{( o , i , h , v )}^{( L )} = \frac{{γ}_{( o )}^{( L )}}{\sqrt{{σ}_{( o )}^{( L )} + ε}} {w}_{( o , i , h , v )}^{( L )} & [ Equation 9 ]\end{matrix}$$

Variable w1 is a new replacement for the variable w, and is weight data in the DC layer L1. That is, in the convolution processing in the DC layer L1, the computation indicated in [Equation 10] below is performed.

$$\begin{matrix}[ Math . 10 ] & \\ {C}_{( o , s , t )}^{( L )} = {\sum }_{i} {\sum }_{( h , v )} w {1}_{( o , i , h , v )}^{( L )} {x}_{( i , s + h , t + v )}^{( L )} + {b}_{( o )}^{( L )} & [ Equation 10 ]\end{matrix}$$

As illustrated in [Equation 10], the variable w1 in the DC layer L1 is obtained by incorporating the parameters of the BN layer L2. That is, it means that the function given to the BN layer L2 by the parameters acquired by the BN layer L2 through learning is incorporated into the DC layer L1.

As a result, the BN layer L2 can be eliminated from the DNN after quantization.

In step S106, the CPU 11 executes Quantize Weight processing (weight quantization processing) on this new weight data (variable w1). Then, the CPU 11 performs relearning processing in step S107 in order to optimize the learning model that has become unoptimized due to the weight quantization processing.

In such a way, the quantization of the activation data and the quantization of the weight data are performed separately, and the relearning processing is performed for each of them, so that it is possible to reduce the amount of computation and reduce the weight while preventing the deterioration of the inference performance.

### 5. Modification Example

A modification example of the quantization flow will be described.

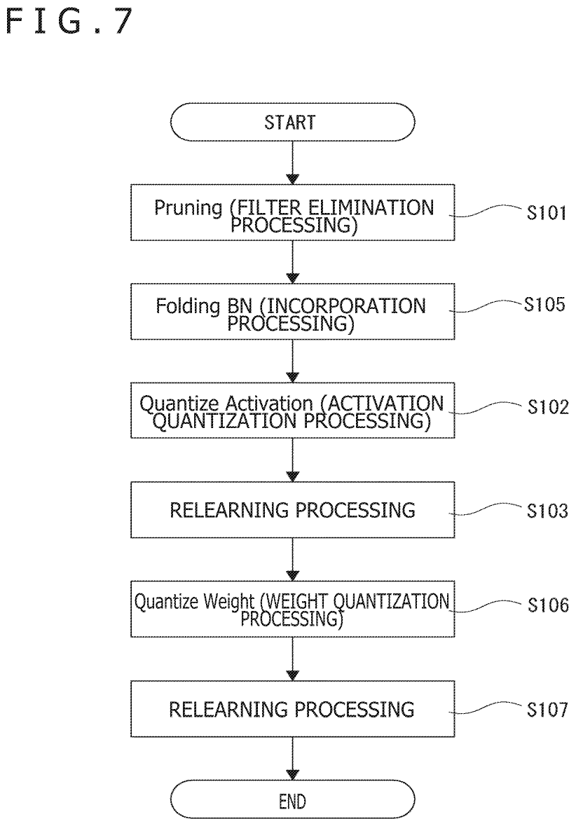

A modification example of the quantization flow illustrated in FIG. 5 is illustrated in FIG. 7.

The CPU 11 first executes Pruning processing (filter elimination processing) in step S101. The details of this processing are similar to those described with reference to FIG. 6.

Subsequently, the CPU 11 performs Folding BN processing (incorporation processing) in step S105. The incorporation processing incorporates the parameters to be used in the BN layer L2 into the immediately preceding DC layer L1, so that the BN layer L2 can be eliminated.

Next, the CPU 11 performs Quantize Activation (activation quantization processing) in step S102, and performs relearning processing in step S103. As a result, an optimal learning model that follows changes in parameters due to activation quantization processing is constructed.

Finally, in step S106, the CPU 11 executes Quantize Weight processing (weight quantization processing) on the new weight data (variable w1) obtained by conversion in step S102, and performs relearning processing in step S107. As a result, an optimal learning model that follows changes in parameters due to weight quantization processing is constructed.

According to the modification example illustrated in FIG. 7, since the number of executions of the filter elimination processing is set to one, the amount of computation can be reduced at the time of proceeding with the quantization of the DNN.

In the example described above, attention is paid to the DC layer L1. That is, an example has been described in which filter elimination processing is performed on the BN layer L2 in a case where the BN layer L2 is arranged immediately after the DC layer L1. Not limited to this, the present technique is widely applicable in a case where a BN layer is arranged immediately after a convolutional layer. In the above example, the BN layer L5 is arranged immediately after the PC layer L4, so the filter elimination processing may be performed on the BN layer L5. Due to this, the quantization error can be reduced by narrowing the dynamic range.

### 6. Summary

As described above, the information processing apparatus 1 includes the filter elimination processing section 33 that eliminates filters whose σ is smaller than a threshold value (variable ε) in a neural network (for example, DNN) having a Depthwise convolutional layer (DC layer L1), a Pointwise convolutional layer (PC layer L4), and a Batch normalization layer (BN layers L2 and L5), and includes the quantization processing section 32 that quantizes the neural network.

By eliminating filters with small variance, the neural network can be quantized while maintaining the magnitude relation and difference between respective parameters as much as possible.

Therefore, the quantization of the neural network reduces the amount of computation and hardware costs, and reduces the quantization error as well, so as to suppress the deterioration of the inference performance. Due to this, a learning model can be obtained that is suitable for the case of performing inference processing in a small computer device, a smartphone, or the like that does not have high processing ability.

Also, since there is no need to reconstruct the learning model acquired before quantization, a processing load and processing time required to acquire the quantized learning model can be reduced.

As described in FIG. 5 and the like, the filter elimination processing section 33 of the information processing apparatus 1 may set the filter in the Batch normalization layer (BN layer L2) subsequent to the Depthwise convolution layer (DC layer L1) as a filter to be eliminated.

In the subsequent stage of the Depthwise convolutional layer, especially in the Batch normalization layer immediately thereafter, there may be filters with small variance.

By eliminating such filters, the quantization error can be reduced.

As described by using [Equation 7], the filter elimination processing section 33 of the information processing apparatus 1 may replace the output value of the Batch normalization layer (BN layer L2) with the approximate expression ([Equation 7]) as elimination of the filter.

This makes it possible to reduce the quantization error.

Further, the amount of computation when applying the filter can also be reduced.

As described by using FIG. 4 and the like, the adjustment processing section 34 may be provided to adjust the parameters in the convolution layer (PC layer L4) provided after the Batch normalization layer (BN layer L2) from which the filter has been eliminated.

For example, the parameters are adjusted so that the effect of eliminating the filter on the inference performance is reduced.

Due to this, it is possible to reduce the influence of filter elimination on inference performance, and suppress degradation in inference performance. Also, the amount of computation can be reduced.

As described by using [Equation 8], the adjustment processing section 34 may adjust bias parameters of the convolution layer (PC layer L4) provided after the Batch normalization layer (BN layer L2).

This can reduce the influence of filter elimination on inference results.

Therefore, degradation of inference performance can be suppressed.

As described by using FIG. 4 and the like, the information processing apparatus 1 may be provided with the incorporation processing section 35 that incorporates the parameters in the Batch normalization layers (BN layers L2 and L5) into other convolution layers (for example, the DC layer L1 and the PC layer L4).

This makes it possible, for example, to eliminate layers from which filters have been eliminated.

Therefore, it is possible to achieve a significant reduction in the amount of computation together with parameter quantization.

As described by using [equation 9] and the like, the incorporation processing section 35 may perform processing for incorporating the parameters in the Batch normalization layer (BN layer L2) into the preceding Depthwise convolution layer (DC layer L1).

As a result, the functions acquired by the Batch normalization layer as the learning result are integrated into the Depthwise convolution layer.

Therefore, the degradation of inference performance can be suppressed even if the Batch normalization layer is eliminated.

As described with reference to FIG. 6 and the like, in the information processing apparatus 1, the variable ε to be added to the denominator in order to avoid division by zero in the Batch normalization layer (BN layer L2) may be used as the threshold.

This eliminates the need for the user to enter the threshold.

Therefore, the burden on the user can be reduced.

As described above, the information processing apparatus 1 includes the quantization processing section 32 that quantizes a neural network (for example, DNN), and the quantization processing section 32 performs quantization of activation data in the neural network and quantization of the weight data in the neural network separately.

As a result, changes in inference results due to quantization of activation data and changes in inference results due to quantization of weight data are reduced compared to a case where both are quantized at one time.

Therefore, performance degradation after quantization can be suppressed, and the time required for relearning can be shortened.

As described with reference to FIG. 5 and the like, the quantization processing section 32 may perform relearning processing after quantization of the activation data and after quantization of the weight data, respectively.

By relearning, the optimal learning model that has changed due to quantization can be followed.

Therefore, deterioration of inference performance can be suppressed. Also, for example, in the case of quantizing from 32 to 8 bits, it is not necessary to build a 32-bit learning model again, so that the time required for relearning processing can be shortened.

As described with reference to FIG. 4 and the like, the information processing apparatus 1 may include the filter elimination processing section 33 that eliminates filters whose variance is smaller than a threshold.

By eliminating filters with small variance, the neural network can be quantized while maintaining the magnitude relation and difference between respective parameters as much as possible.

Therefore, the amount of computation is reduced by quantizing the neural network, and also, the quantization error can be reduced in order to suppress the deterioration of the inference performance. Due to this, it is suitable in the case of inference processing using small computer devices, smartphones, and the like that do not have high processing ability.

As described with reference to FIGS. 5 and 7, the quantization processing section 32 may perform quantization of the activation data and weight data after the filter elimination processing section 33 executes filter elimination.

As a result, quantization and relearning are performed with the dynamic range of the parameters narrowed.

Therefore, the performance of the learning model acquired by relearning does not degrade too much.

As described with reference to FIG. 5 and the like, the filter elimination processing section 33 may eliminate filters before and after quantization of activation data, respectively.

As a result, even in a case where a problematic filter that widens the dynamic range appears after quantization of the activation data, the filter is eliminated.

Therefore, the performance of the learning model does not degrade further.

As described with reference to FIG. 7 and the like, the filter elimination processing section 33 eliminates the filter only once and the quantization processing section 32 may quantize the activation data and the weight data after the elimination of the filter performed once.

As a result, the time required for filter elimination processing can be shortened.

Therefore, it is suitable for the case of executing filter elimination processing and quantization processing in a computer device with low processing ability.

It should be noted that the effects described in the present specification are merely examples, and the present technique are not limited thereto and may also have other effects.

### 7. Present Technique

(1)

An information processing apparatus including:
a filter elimination processing section that eliminates a filter whose variance is smaller than a threshold in a neural network having a Depthwise convolution layer, a Pointwise convolution layer, and a Batch normalization layer; and
a quantization processing section that quantizes the neural network.

(2)

The information processing apparatus according to (1), in which
the filter elimination processing section sets the filter in the Batch normalization layer subsequent to the Depthwise convolution layer as the filter to be eliminated.

(3)

The information processing apparatus according to (2), in which
the filter elimination processing section replaces an output value of the Batch normalization layer with an approximate expression in elimination of the filter.

(4)

The information processing apparatus according to any one of (2) to (3), further including:
an adjustment processing section that adjusts a parameter in a convolution layer provided subsequent to the Batch normalization layer from which the filter is eliminated.

(5)

The information processing apparatus according to (4), in which
the adjustment processing section adjusts a bias parameter of the convolution layer provided subsequent to the Batch normalization layer.

(6)

The information processing apparatus according to any one of (1) to (5), further including:
an incorporation processing section that incorporates a parameter in the Batch normalization layer into another convolution layer.

(7)

The information processing apparatus according to (6), in which
the incorporation processing section incorporates the parameter in the Batch normalization layer into a preceding Depthwise convolution layer.

(8)

The information processing apparatus according to any one of (1) to (7), in which
a variable to be added to a denominator to avoid division by zero in the Batch normalization layer is used, as the threshold.

(9)

A method for processing information, in which
a computer device executes
   a process of eliminating a filter whose variance is less than a threshold in a neural network having a Depthwise convolutional layer, a Pointwise convolutional layer, and a Batch normalization layer, and
   a process of quantizing the neural network.

(10)

An information processing apparatus including:
a quantization processing section that quantizes a neural network, in which
the quantization processing section performs quantization of activation data in the neural network and quantization of weight data in the neural network separately.

(11)

The information processing apparatus according to (10), further including:
a learning model generating section that performs relearning processing after the quantization of the activation data and after the quantization of the weight data, respectively.

(12)

The information processing apparatus according to any one of (10) to (11), in which
the neural network has a Depthwise convolutional layer, a Pointwise convolutional layer, and a Batch normalization layer, and
the information processing apparatus further includes a filter elimination processing section that eliminates a filter whose variance is smaller than a threshold value in the neural network, and a filter elimination processing section that eliminates a filter whose variance is smaller than a threshold value.

(13)

The information processing apparatus according to (12), in which
the quantization processing section performs the quantization of the activation data and the quantization of the weight data after the filter is eliminated by the filter elimination processing section.

(14)

The information processing apparatus according to (13), in which
the filter elimination processing section eliminates the filter before and after the quantization of the activation data, respectively.

(15)

The information processing apparatus according to (13), in which
the filter elimination processing section eliminates the filter only once, and
the quantization processing section performs the quantization of the activation data and the quantization of the weight data after the filter is eliminated once.

(16)

A method for processing information in which
a computer device performs quantization of activation data in a neural network and quantization of weight data in the neural network separately.

### REFERENCE SIGNS LIST

1: Information processing apparatus
31: Learning model generating section
32: Quantization processing section
33: Filter elimination processing section
34: Adjustment processing section
35: Incorporation processing section
L1: DC layer (Depthwise convolution layer)
L2, L5: BN layer (Batch normalization layer)
L4: PC layer (Pointwise convolution layer)

1. An information processing apparatus comprising:
a filter elimination processing section that eliminates a filter whose variance is smaller than a threshold in a neural network having a Depthwise convolution layer, a Pointwise convolution layer, and a Batch normalization layer; and
a quantization processing section that quantizes the neural network.

2. The information processing apparatus according to claim 1, wherein
the filter elimination processing section sets the filter in the Batch normalization layer subsequent to the Depthwise convolution layer as the filter to be eliminated.

3. The information processing apparatus according to claim 2, wherein
the filter elimination processing section replaces an output value of the Batch normalization layer with an approximate expression in elimination of the filter.

4. The information processing apparatus according to claim 2, further comprising:
an adjustment processing section that adjusts a parameter in a convolution layer provided subsequent to the Batch normalization layer from which the filter is eliminated.

5. The information processing apparatus according to claim 4, wherein
the adjustment processing section adjusts a bias parameter of the convolution layer provided subsequent to the Batch normalization layer.

6. The information processing apparatus according to claim 1, further comprising:
an incorporation processing section that incorporates a parameter in the Batch normalization layer into another convolution layer.

7. The information processing apparatus according to claim 6, wherein
the incorporation processing section incorporates the parameter in the Batch normalization layer into a preceding Depthwise convolution layer.

8. The information processing apparatus according to claim 1, wherein
a variable to be added to a denominator to avoid division by zero in the Batch normalization layer is used, as the threshold.

9. A method for processing information, wherein
a computer device executes steps of
a process of eliminating a filter whose variance is less than a threshold in a neural network having a Depthwise convolutional layer, a Pointwise convolutional layer, and a Batch normalization layer, and
a process of quantizing the neural network.

10. An information processing apparatus comprising:
a quantization processing section that quantizes a neural network, wherein
the quantization processing section performs quantization of activation data in the neural network and quantization of weight data in the neural network separately.

11. The information processing apparatus according to claim 10, further comprising:
a learning model generating section that performs relearning processing after the quantization of the activation data and after the quantization of the weight data, respectively.

12. The information processing apparatus according to claim 10, wherein
the neural network has a Depthwise convolutional layer, a Pointwise convolutional layer, and a Batch normalization layer, and
the information processing apparatus further includes a filter elimination processing section that eliminates a filter whose variance is smaller than a threshold value in the neural network.

13. The information processing apparatus according to claim 12, wherein
the quantization processing section performs the quantization of the activation data and the quantization of the weight data after the filter is eliminated by the filter elimination processing section.

14. The information processing apparatus according to claim 13, wherein
the filter elimination processing section eliminates the filter before and after the quantization of the activation data, respectively.

15. The information processing apparatus according to claim 13, wherein
the filter elimination processing section eliminates the filter only once, and
the quantization processing section performs the quantization of the activation data and the quantization of the weight data after the filter is eliminated once.

16. A method for processing information, wherein
a computer device performs quantization of activation data in a neural network and quantization of weight data in the neural network separately.
